(19) United States
(12) Patent Application Publication
(10) Pub. No.: US 2009/0180031 A1
(43) Pub. Date: Jul. 16, 2009

(54) GAMMA VOLTAGE DRIVING CIRCUIT AND RELATED METHOD

(76) Inventors: Wei-Shan Chiang, Tai-Chung City (TW); Ming-Huang Liu, Taipei Hsien (TW); Hsiu-Ping Lin, Hsin-Chu Hsien (TW); Meng-Yong Lin, Hsinchu City (TW); Chen-Hsien Han, Hsinchu City (TW); Wei-Yang Ou, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 12/353,264

(22) Filed: Jan. 14, 2009

(30) Foreign Application Priority Data
Jan. 14, 2008 (TW) 097101322

(51) Int. Cl. H04N 9/69

(52) U.S. Cl. 348/675; 348/E11.001

(57) ABSTRACT

A Gamma voltage driving circuit includes a setting circuit, a Gamma voltage generator, and a plurality of voltage output modules. The setting circuit respectively outputs a plurality of Gamma voltage setting signals at different time slots. The Gamma voltage generator respectively transforms the plurality of Gamma voltage setting signals into a plurality of corresponding voltage levels. The plurality of voltage output modules respectively provides voltage outputs at different time slots. Each voltage output module includes a plurality of voltage output circuits and a plurality of output control circuits. Each voltage output circuit includes a voltage selecting unit and an output buffering unit. The output control circuit controls the voltage output circuit to selectively output Gamma voltages.

### BACKGROUND OF THE INVENTION

1. Field of the Invention

The present invention relates to a Gamma voltage driving circuit and a related method, and more particularly, to a Gamma voltage driving circuit and a related method that shares a Gamma voltage generator through timing controls.

2. Description of the Prior Art

In recent times, flat panel display (FPDs) with their flat, thin form factor and high-resolution image quality are getting more and more attention and undergoing explosive growth in the consumer market. The major types of FPDs include plasma display panels (PDP), liquid crystal displays (LCD), and rear projection displays. These flat panel displays feature several shared benefits of thin form factor and high-resolution image quality and have largely replaced cathode ray tube displays (CRT). Hence, flat panel displays are widely applied to information products such as notebook computers, personal digital assistants (PDA), flat televisions and mobile phones. In order to improve the color quality of the flat panel displays, three Gamma voltages (such as Red, Green, and Blue) are adopted to control the flat panel displays in order to make the displayed color more precise.

Please refer to FIG. 1. FIG. 1 is a simplified diagram showing a Gamma voltage generator of a flat panel display according to the prior art. As shown in FIG. 1, in total there are three Gamma voltage generators 110-130. Each of the Gamma voltage generators 110-130 is an R-ladder type, i.e., composed of multiple resistors in series. After m external settings are respectively inputted, the Gamma voltage generators 110-130 then respectively transfer the m external settings into n Gamma voltages to provide the usage of the source driver of the flat panel display. The Gamma voltage generators 110-130 are respectively used for generating Gamma voltages with R, G, and B.

Conventional flat panel displays always adopt three Gamma voltage generators for respectively generating Gamma voltages with R, G, and B. However, in order to provide a display panel with higher quality, the Gamma voltage generator needs to provide more different voltage levels to conform to data transmission with more bits. Thus, the more voltage levels the Gamma voltage generator needs to provide, the larger the circuit becomes, which is not economical.

### SUMMARY OF THE INVENTION

It is therefore one of the objectives of the present invention to provide a Gamma voltage driving circuit and a related method to solve the abovementioned problems.

According to an exemplary embodiment of the present invention, a Gamma voltage driving circuit is provided. The Gamma voltage driving circuit includes a setting circuit, a Gamma voltage generator, and a plurality of voltage output modules. The setting circuit is used for respectively outputting a plurality of Gamma voltage setting signals at different time slots, wherein the plurality of Gamma voltage setting signals respectively correspond to different color constituents. The Gamma voltage generator is coupled to the setting circuit for receiving the plurality of Gamma voltage setting signals and for respectively transforming the plurality of Gamma voltage setting signals into a plurality of corresponding voltage levels. The plurality of voltage output modules are coupled to the Gamma voltage generator. The plurality of voltage output modules respectively correspond to different color constituents and respectively provide voltage outputs at different time slots. Each voltage output module includes a plurality of voltage output circuits and a plurality of output control circuits. Each voltage output circuit includes a voltage selecting unit and an output buffering unit. The voltage selecting unit is used for choosing a target voltage level from the plurality of corresponding voltage levels according to a selecting signal. The output buffering unit is coupled to the voltage selecting unit for buffering the target voltage level selected by the voltage selecting unit. The plurality of output control circuits are respectively coupled to the plurality of voltage output circuits. Each output control circuit is used for controlling the corresponding voltage output circuit to selectively output the target voltage level.

In one embodiment, each output control circuit includes a first switch coupled between an output end of the corresponding voltage output circuit and an output buffering unit of the corresponding voltage output circuit for selectively being turned on or turned off according to a first switch signal.

In one embodiment, the setting circuit includes a plurality of setting switches respectively coupled between the plurality of Gamma voltage setting signals and the Gamma voltage generator. The plurality of setting switches are respectively selectively turned on or turned off according to a plurality of setting switch signals to respectively output the plurality of Gamma voltage setting signals to the Gamma voltage generator at different time slots.

In one embodiment, the Gamma voltage driving circuit is applied to a flat panel display.

According to an exemplary embodiment of the present invention, a method for generating Gamma voltages is provided. The method includes respectively outputting a plurality of Gamma voltage setting signals at different time slots, wherein the plurality of Gamma voltage setting signals respectively correspond to different color constituents; receiving the plurality of Gamma voltage setting signals and respectively transforming the plurality of Gamma voltage setting signals into a plurality of corresponding voltage levels; choosing a target voltage level from the plurality of corresponding voltage levels according to a selecting signal; buffering the target voltage level selected by the voltage selecting unit; and controlling whether to output the target voltage level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified diagram showing a Gamma voltage generator of a flat panel display according to the prior art.

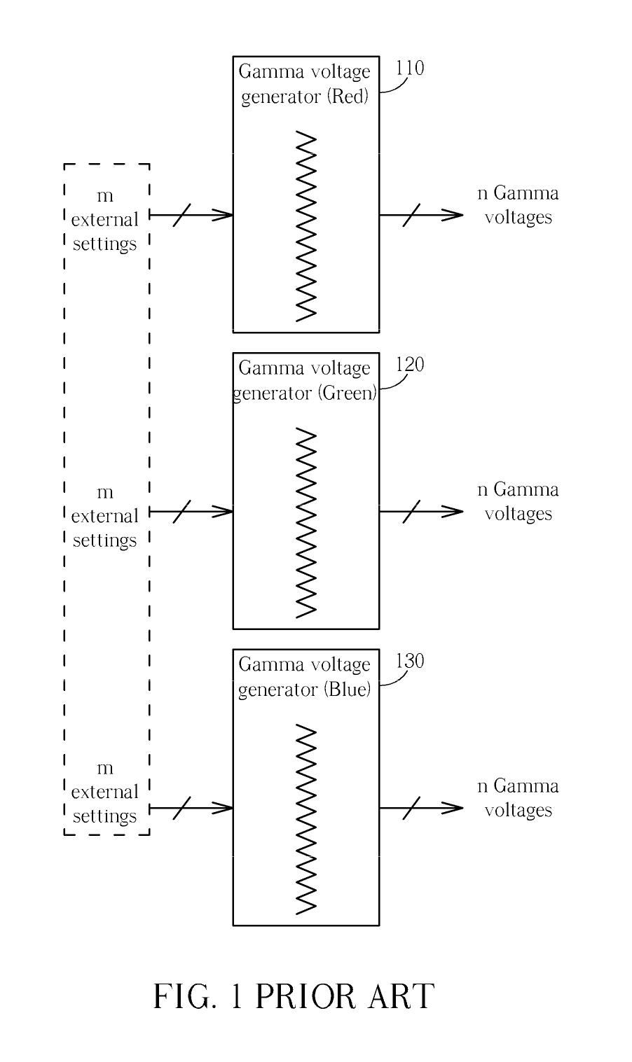

FIG. 2 is a diagram showing a Gamma voltage driving circuit according to a first embodiment of the present invention.

FIG. 3 is a timing diagram of each switch signal of the Gamma voltage driving circuit shown in FIG. 2.

FIG. 4 is a diagram showing a Gamma voltage driving circuit according to a second embodiment of the present invention.

FIG. 5 is a diagram showing a Gamma voltage driving circuit according to a third embodiment of the present invention.

FIG. 6 is a timing diagram of each switch signal of the Gamma voltage driving circuit shown in FIG. 5.

FIG. 7 is a diagram showing a Gamma voltage driving circuit according to a fourth embodiment of the present invention.

FIG. 8 is a diagram showing a Gamma voltage driving circuit according to a fifth embodiment of the present invention.

FIG. 9 is a diagram showing a plurality of voltage output circuits that correspond to an identical pixel sharing an identical output buffering unit.

FIG. 10 is a flowchart illustrating a method for generating Gamma voltages according to an exemplary embodiment of the present invention.

### DETAILED DESCRIPTION

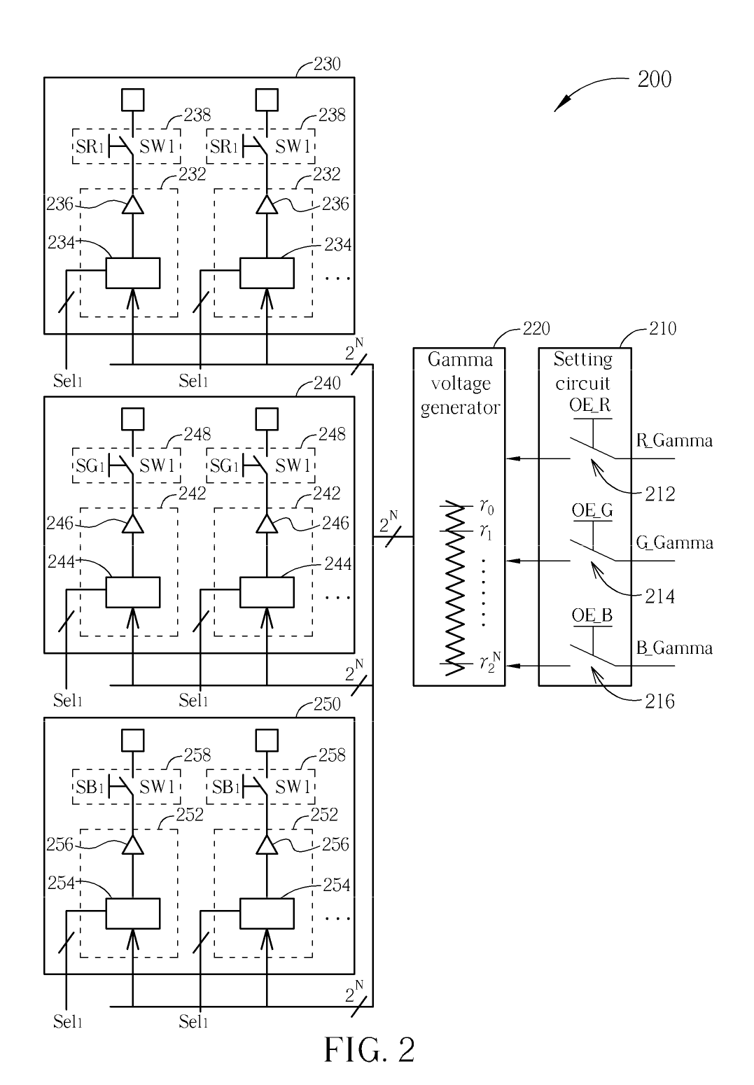

Please refer to FIG. 2. FIG. 2 is a diagram showing a Gamma voltage driving circuit 200 according to a first embodiment of the present invention. The Gamma voltage driving circuit 200 includes a setting circuit 210, a Gamma voltage generator 220, and a plurality of voltage output modules 230-250. In this embodiment, there are three voltage output modules, which respectively correspond to different color constituents, such as R, G, and B, and respectively provide voltage outputs at different time slots within a period of a scan line. The setting circuit 210 is used for respectively outputting a plurality of Gamma voltage setting signals R_Gamma, G_Gamma, and B_Gamma at different time slots, wherein the plurality of Gamma voltage setting signals R_Gamma, G_Gamma, and B_Gamma respectively correspond to different color constituents, i.e., the abovementioned R, G, and B. The Gamma voltage generator 220 is coupled to the setting circuit 210 for receiving the plurality of Gamma voltage setting signals R_Gamma, G_Gamma, and B_Gamma and for respectively transforming the plurality of Gamma voltage setting signals R_Gamma, G_Gamma, and B_Gamma into a plurality of corresponding voltage levels. A number N represents a resolution of each color constituent.

Please note that the abovementioned Gamma voltage generator 220 can be implemented by an R-ladder, i.e., being composed of multiple resistors, but is not limited to this only and can be implemented by other elements. Furthermore, the number N is not a fixed value and can be adjusted depending on practical applications.

Please keep referring to FIG. 2. The voltage output modules 230-250 are coupled to the Gamma voltage generator 220. Each of the voltage output modules 230-250 respectively includes a plurality of voltage output circuits and a plurality of output control circuits, wherein each voltage output circuit corresponds to an output channel. For example, the voltage output module 230 includes a plurality of voltage output circuits 232 and a plurality of output control circuits 238, the voltage output module 240 includes a plurality of voltage output circuits 242 and a plurality of output control circuits 248, and the voltage output module 250 includes a plurality of voltage output circuits 252 and a plurality of output control circuits 258. In FIG. 2, only two voltage output circuits and two output control circuits are represented for illustration. In the following, the voltage output circuit 232 and the output control circuit 238 of the voltage output module 230 are taken as examples for illustration. Each voltage output circuit 232 includes a voltage selecting unit 234 and an output buffering unit 236. The voltage selecting unit 234 chooses a target voltage level Vₜ from the plurality of (2^{N}) corresponding voltage levels according to a selecting signal Sel₁ (also called a color data signal). The output buffering unit 236 is coupled to the voltage selecting unit 234 for buffering the target voltage level Vₜ selected by the voltage selecting unit 234. The plurality of output control circuits 238 are respectively coupled to the plurality of voltage output circuits 232, wherein each output control circuit 238 is used for controlling the corresponding voltage output circuit 232 to output the target voltage level Vₜ. The rest can be deduced by analogy; the coupling manner and operations of each element of the voltage output modules 240 and 250 are the same as that of the voltage output module 230, and further descriptions herein are omitted.

In this embodiment, the abovementioned output control circuits 238, 248, and 258 can include a first switch SW1, but is not limited to this and can be implemented by other elements. It will be obvious to those skilled in the art that various modifications of the output control circuits 238, 248, and 258 may be made without departing from the spirit of the present invention. Taking the voltage output circuit 232 and the output control circuit 238 included by the voltage output module 230 as an example, the first switch SW1 of the output control circuit 238 is coupled between an output end of the corresponding voltage output circuit 232 and the output buffering unit 236 of the corresponding voltage output circuit 232 for selectively being turned on or turned off according to a first switch signal SR₁. The rest may be deduced by analogy. The first switch SW1 of the output control circuit 248 is selectively turned on or turned off according to a first switch signal SG₁, and the first switch SW1 of the output control circuit 258 is selectively turned on or turned off according to a first switch signal SB₁.

In one embodiment, the setting circuit 210 can include a plurality of setting switches 212-216 (only three setting switches 212-216 are presented in FIG. 2 for illustration). This is merely an example for describing the present invention, and in no way should be considered a limitation of the present invention. The setting switches 212-216 are respectively coupled between the plurality of Gamma voltage setting signals R_Gamma, G_Gamma, and B_Gamma and the Gamma voltage generator 220. The setting switches 212-216 are respectively selectively turned on or turned off according to a plurality of setting switch signals OE_R, OE_G, and OE_B to respectively output the plurality of Gamma voltage setting signals R_Gamma, G_Gamma, and B_Gamma to the Gamma voltage generator 220 at different time slots. Operations of each switch and each element of the Gamma voltage driving circuit 200 are detailed in the following embodiments.

Please note that the abovementioned Gamma voltage driving circuit 200 can be applied to a flat panel display, but is not limited to this only and can be applied to other devices.

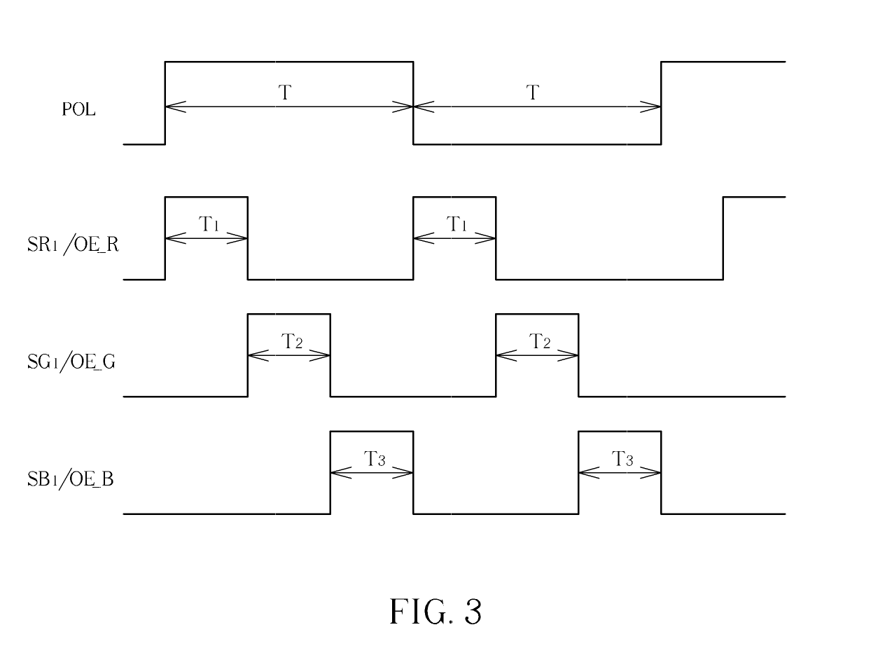

Please refer to FIG. 3 together with FIG. 2. FIG. 3 is a timing diagram of each switch signal of the Gamma voltage driving circuit 200 shown in FIG. 2. As shown in FIG. 3, the timing of a polarity signal POL, the first switch signal SR₁ (with the setting switch signal OE_R), the first switch signal SG₁ (with the setting switch signal OE_G), and the first switch signal SB₁ (with the setting switch signal OE_B) are shown in order. The polarity signal POL is used for controlling the timing for inverting the polarity for driving voltages. In this embodiment, T represents a time that a flat panel display scans a scan line. In addition, the time T of a scan line is divided into several time segments T₁, T₂, and T₃ in this embodiment. In practice, however, these time segments T₁, T₂, and T₃ are not limited to be identical in the present invention. The following description details how each element operates by collocating the timing diagram of each switch signal shown in FIG. 3 and the elements shown in FIG. 2.

During the time segment T₁, only the first switch SW1 controlled by the first switch signal SR₁ and the setting switch 212 controlled by the setting switch signal OE_R are allowed to be turned on. At this time, the setting circuit 210 outputs the Gamma voltage setting signal R_Gamma, and the Gamma voltage generator 220 then transforms the Gamma voltage setting signal R_Gamma into a plurality of (2^{N}) corresponding voltage levels to output. Due to only the first switch SW1 being controlled by the first switch signal SR1 (i.e., the output control circuit 238) being turned on, only the voltage output circuits 232 included in the voltage output module 230 can output the selected target voltage level Vₜ, and so forth. During the time segment T₂, only the first switch SW1 controlled by the first switch signal SG₁ and the setting switch 214 controlled by the setting switch signal OE_G are allowed to be turned on. At this time, only the voltage output circuits 242 included by the voltage output module 240 can output the selected target voltage level Vₜ, and so forth. During the time segment T₃, only the first switch SW1 controlled by the first switch signal SB₁ and the setting switch 216 controlled by the setting switch signal OE_B are allowed to be turned on. At this time, only the voltage output circuits 252 included by the voltage output module 250 can output the selected target voltage level Vₜ.

Through collocating the control of each switch of the output control circuits 238, 248, and 258 together with the choices of each switch of the setting circuit 210, the Gamma voltage driving circuit 200 can sequentially drive the Gamma voltages with red, green, and blue within the time T of a scan line. Through the concept of time-sharing and multi-work, only one Gamma voltage generator 220 is needed to complete the abovementioned actions. Not only can circuits be simplified but manufacturing cost and occupied area can also be saved.

Please note that the abovementioned first switch signal SR₁ and the setting switch signal OE_R are signals adopting the same timing, the first switch signal SG₁ and the setting switch signal OE_G are signals adopting the same timing, and the first switch signal SB₁ and the setting signal OE_B are signals adopting the same timing, and that this is merely an example for illustrating the present invention. In other embodiments, these signals can be implemented by signals adopting different timings. For example, a delay time exists between the first switch signal SR₁ and the setting switch signal OE_R, and they can be simultaneously turned on during a period of overlapped time.

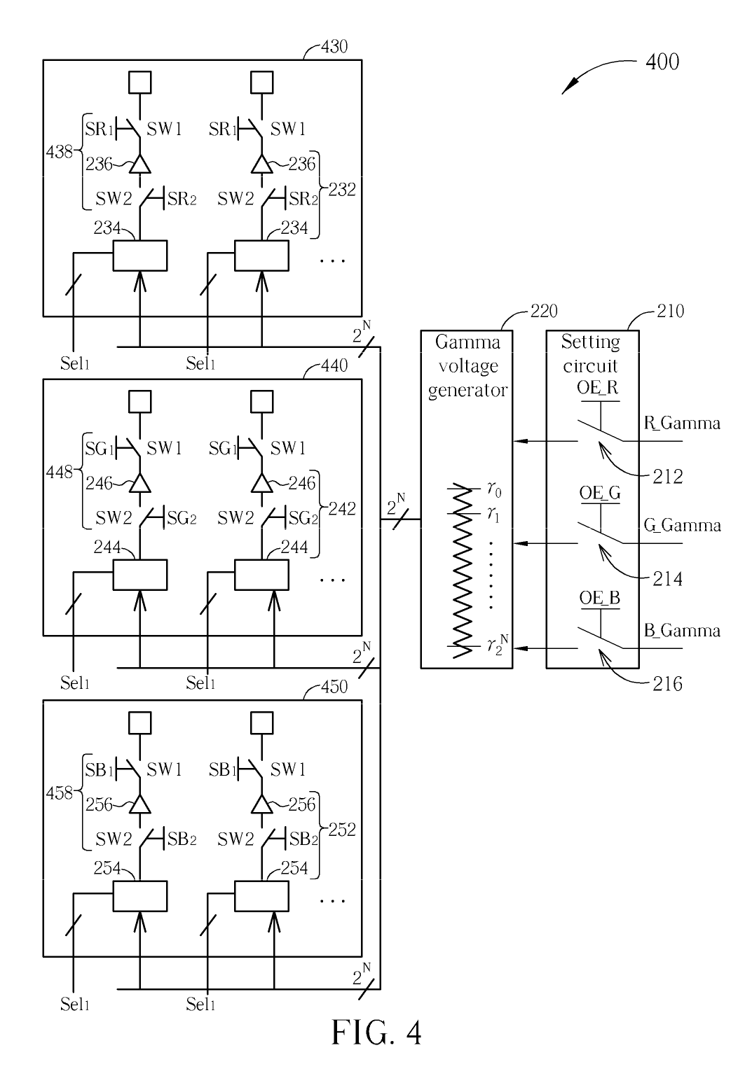

The abovementioned embodiments are presented merely for describing the present invention, and in no way should be considered to be limitations of the scope of the present invention. Those skilled in the art should observe that various modifications of the output control circuits 238, 248, and 258 may be made without departing from the spirit of the present invention. Please refer to FIG. 4. FIG. 4 is a diagram showing a Gamma voltage driving circuit 400 according to a second embodiment of the present invention. The Gamma voltage driving circuit 400 shown in FIG. 4 is similar to the Gamma voltage driving circuit 200 shown in FIG. 2, the difference between them being that each of the output control circuits 438, 448, and 458 of the voltage output modules 430-450 included by the Gamma voltage driving circuit 400 further includes a second switch SW2. Taking the voltage output circuit 232 and the output control circuit 438 of the voltage output module 430 as examples, the first switch SW1 of the output control circuit 438 is coupled between an output end of the corresponding voltage output circuit 232 and the output buffering unit 236 of the corresponding voltage output circuit 232 for selectively being turned on or turned off according to a first switch signal SR₁. The second switch SW2 of the output control circuit 438 is coupled between the output buffering unit 236 and the voltage selecting unit 234 of the corresponding voltage output circuit 232 for selectively being turned on or turned off according to a second switch signal SR₂. The rest may be deduced by analogy. The first switch SW1 of the output control circuit 448 is selectively turned on or turned off according to a first switch signal SG₁, and the second switch SW2 of the output control circuit 448 is selectively turned on or turned off according to a second switch signal SG₂. The first switch SW1 of the output control circuit 458 is selectively turned on or turned off according to a first switch signal SB₁, and the second switch SW2 of the output control circuit 458 is selectively turned on or turned off according to a second switch signal SB₂.

In one embodiment, the first switch signal SR₁, the second switch signal SR₂, and the setting switch signal OE_R are signals adopting the same timing. The first switch signal SG₁, the second switch signal SG₂, and the setting switch signal OE_G are signals adopting the same timing. The first switch signal SB₁, the second switch signal SB₂, and the setting signal OE_B are signals adopting the same timing. Thus the timing diagram of each switch signal of the Gamma voltage driving circuit 400 is the same as the timing diagram shown in FIG. 3. This is merely an example for illustrating the present invention. In other embodiments, these signals can be implemented by signals adopting different timings. For example, delay times exist between the first switch signal SR₁, the second switch signal SR₂, and the setting switch signal OE_R, and they can be simultaneously turned on during a period of overlapped time.

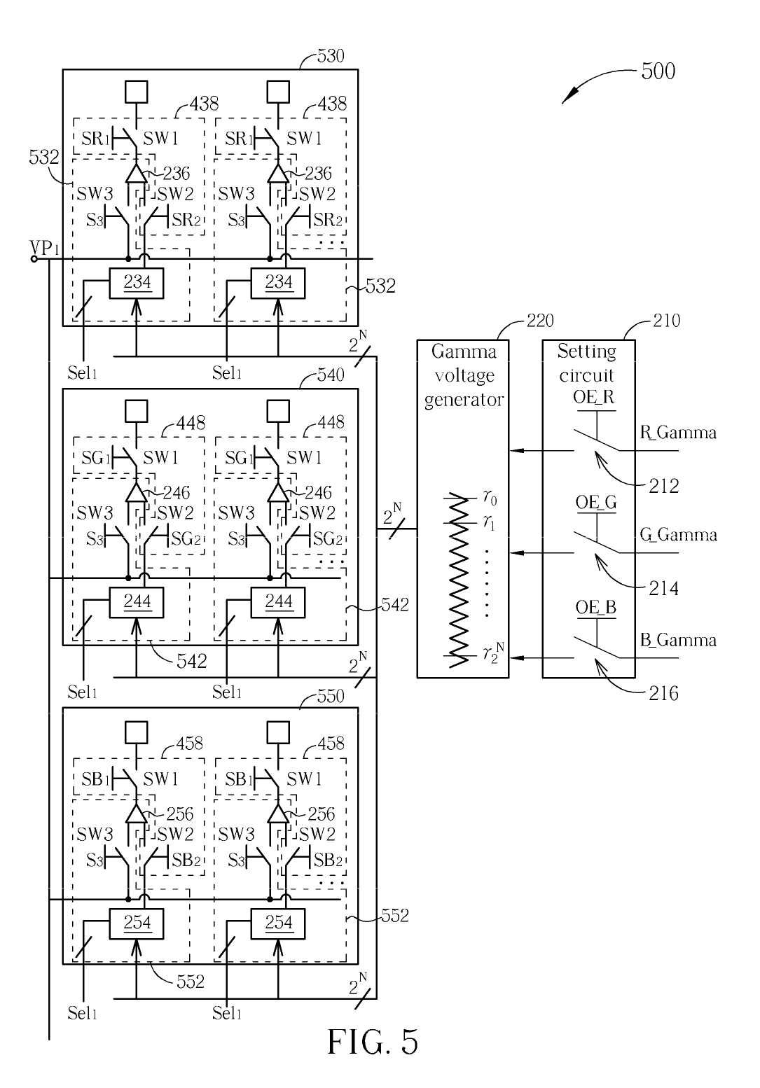

Please refer to FIG. 5. FIG. 5 is a diagram showing a Gamma voltage driving circuit 500 according to a third embodiment of the present invention. The Gamma voltage driving circuit 500 shown in FIG. 5 is similar to the Gamma voltage driving circuit 400 shown in FIG. 4, the difference between them being that each of the voltage output circuits 532, 542, and 552 of the voltage output modules 530-550 included by the Gamma voltage driving circuit 500 further includes a third switch SW3. Taking the voltage output circuit 532 and the output control circuit 438 of the voltage output module 530 as examples, the third switch SW3 of the voltage output circuit 532 is coupled between the output buffering unit 236 and a pre-charging voltage VP₁ for selectively being turned on or turned off according to a third switch signal S₃. The rest may be deduced by analogy. The third switches SW3 of the voltage output circuits 542 and 552 are selectively turned on or turned off according to the third switch signal S₃.

Please note that, in this embodiment, only one of the second switch SW2 of each output control circuit and the third switch SW3 of the corresponding voltage output circuit is allowed to be turned on within an identical time slot. Taking the voltage output circuit 532 and the output control circuit 438 included by the voltage output module 530 as an example, the output buffering unit 236 of the voltage output circuit 532 is coupled to the pre-charging voltage VP₁ to charge its voltage level to the pre-charging voltage VP₁ when the third switch SW3 is turned on. At this time, the second switch SW2 is turned off. When the second switch SW2 is turned on, the output buffering unit 236 of the voltage output circuit 532 is coupled to the voltage selecting unit 234 to output the target voltage level Vₜ selected by the voltage selecting unit 234. At this time, the third switch SW3 is turned off.

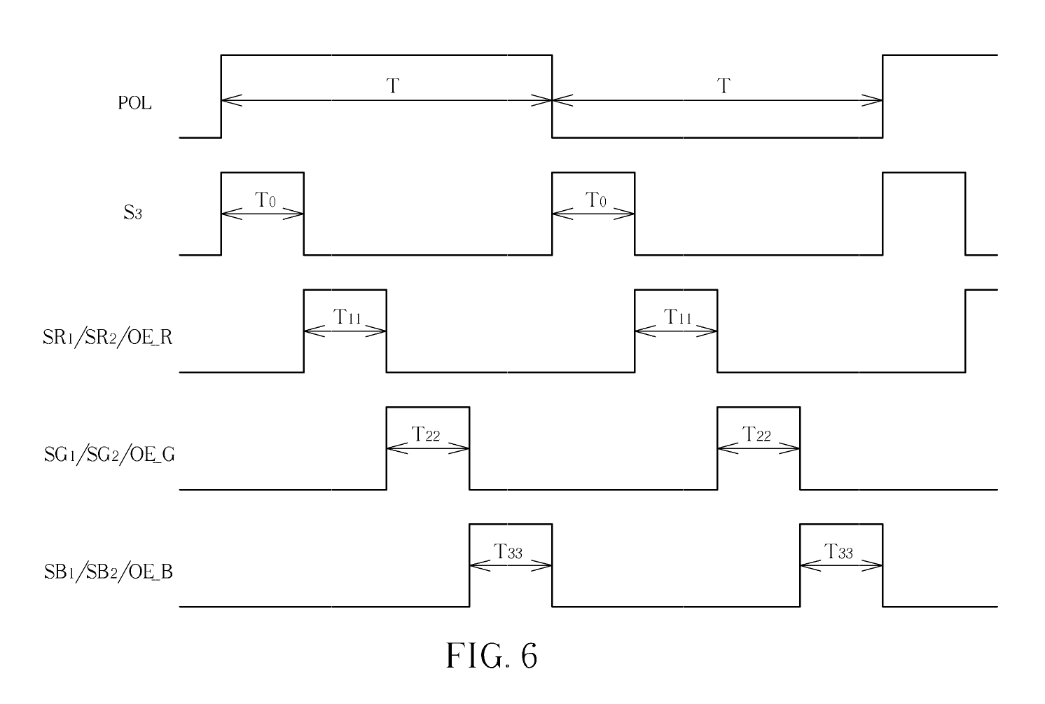

Please refer to FIG. 6 together with FIG. 5. FIG. 6 is a timing diagram of each switch signal of the Gamma voltage driving circuit 500 shown in FIG. 5. As shown in FIG. 6, the timing of the polarity signal POL, the third switch signal S₃, the first switch signal SR₁ (with the second switch signal SR₂ and the setting switch signal OE_R), the first switch signal SG₁ (with the second switch signal SG₂ and the setting switch signal OE_G), and the first switch signal SB₁ (with the second switch signal SB₂ and the setting switch signal OE_B) are shown in order. In this embodiment, T represents a time that a flat panel display scans a scan line. In addition, the time T of a scan line is divided into several time segments T₀, T₁₁, T₂₂, and T₃₃ in this embodiment. The following description details how each element operates by collocating the timing diagram of each switch signal shown in FIG. 6 and the elements shown in FIG. 5.

During the time segment T₀, only the third switch SW3 controlled by the third switch signal S₃ is allowed to be turned on. At this time, the output buffering units 236-256 of the voltage output circuits 532-552 are coupled to the pre-charging voltage VP₁ to charge its corresponding voltage level to the pre-charging voltage VP₁. During the time segment T₁₁, only the first switch SW1 controlled by the first switch signal SR₁, the second switch SW2 controlled by the second switch signal SR₂, and the setting switch 212 controlled by the setting switch signal OE_R are allowed to be turned on. At this time, the setting circuit 210 outputs the Gamma voltage setting signal R_Gamma, and the Gamma voltage generator 220 then transforms the Gamma voltage setting signal R_Gamma into a plurality of (2^{N}) corresponding voltage levels to be output. Due to only the first switch SW1 controlled by the first switch signal SR₁ and the second switch SW2 controlled by the second switch signal SR₂ (i.e., the output control circuit 438) being turned on, only the voltage output circuits 532 included by the voltage output module 530 can output the selected target voltage level Vₜ, and so forth. During the time segment T₂₂, only the first switch SW1 controlled by the first switch signal SG₁, the second switch SW2 controlled by the second switch signal SG₂, and the setting switch 214 controlled by the setting switch signal OE_G are allowed to be turned on. At this time, only the voltage output circuits 542 included by the voltage output module 540 can output the selected target voltage level Vₜ, and so forth. During the time segment T₃₃, only the first switch SW1 controlled by the first switch signal SB₁, the second switch SW2 controlled by the second switch signal SB₂, and the setting switch 216 controlled by the setting switch signal OE_B are allowed to be turned on. At this time, only the voltage output circuits 552 included by the voltage output module 550 can output the selected target voltage level Vₜ.

Please note that the abovementioned first switch signal SR₁, the second switch signal SR₂, and the setting switch signal OE_R are signals adopting the same timing; the first switch signal SG₁, the second switch signal SG₂, and the setting switch signal OE_G are signals adopting the same timing; and the first switch signal SB₁, the second switch signal SB₂, and the setting signal OE_B are signals adopting the same timing, and that this is merely an example for illustrating the present invention. In other embodiments, these signals can be implemented by signals adopting different timings. For example, there is a delay time exists between the first switch signal SR₁, the second switch signal SR₂, and the setting switch signal OE_R, and they can be simultaneously turned on during a period of overlapped time.

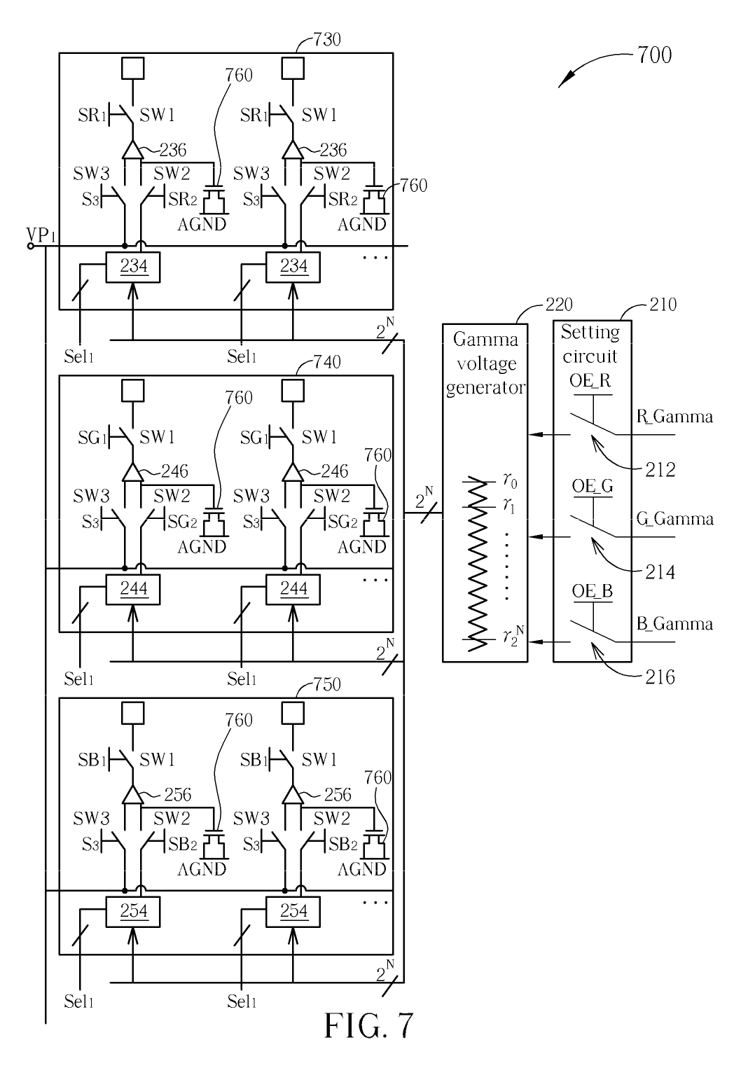

Please refer to FIG. 7. FIG. 7 is a diagram showing a Gamma voltage driving circuit 700 according to a fourth embodiment of the present invention. The Gamma voltage driving circuit 700 shown in FIG. 7 is similar to the Gamma voltage driving circuit 500 shown in FIG. 5, the difference between them being that each of the voltage output circuits of the voltage output modules 730-750 included by the Gamma voltage driving circuit 700 further includes a voltage regulating device 760 coupled between the corresponding voltage selecting units 234-254 and the corresponding output buffering units 236-256.

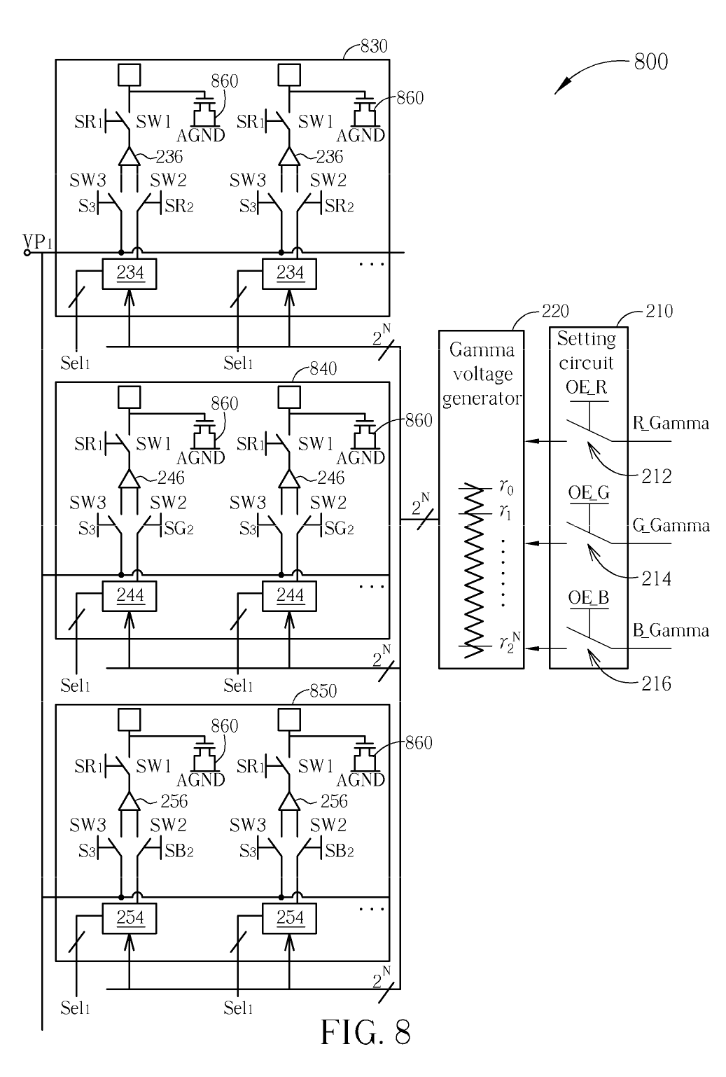

Please refer to FIG. 8. FIG. 8 is a diagram showing a Gamma voltage driving circuit 800 according to a fifth embodiment of the present invention. The Gamma voltage driving circuit 800 shown in FIG. 8 is similar to the Gamma voltage driving circuit 700 shown in FIG. 7, the difference between them being that a position of each voltage regulating device 860 of the voltage output modules 830-850 included by the Gamma voltage driving circuit 800 is different from a position of the voltage regulating device 760 shown in FIG. 7. The voltage regulating device 860 is coupled to an output end of the corresponding output buffering units 236-256.

In one embodiment, the abovementioned voltage regulating devices 760 and 860 can be implemented by a MOSFET, but are not limited to this implementation only and can be implemented by other elements.

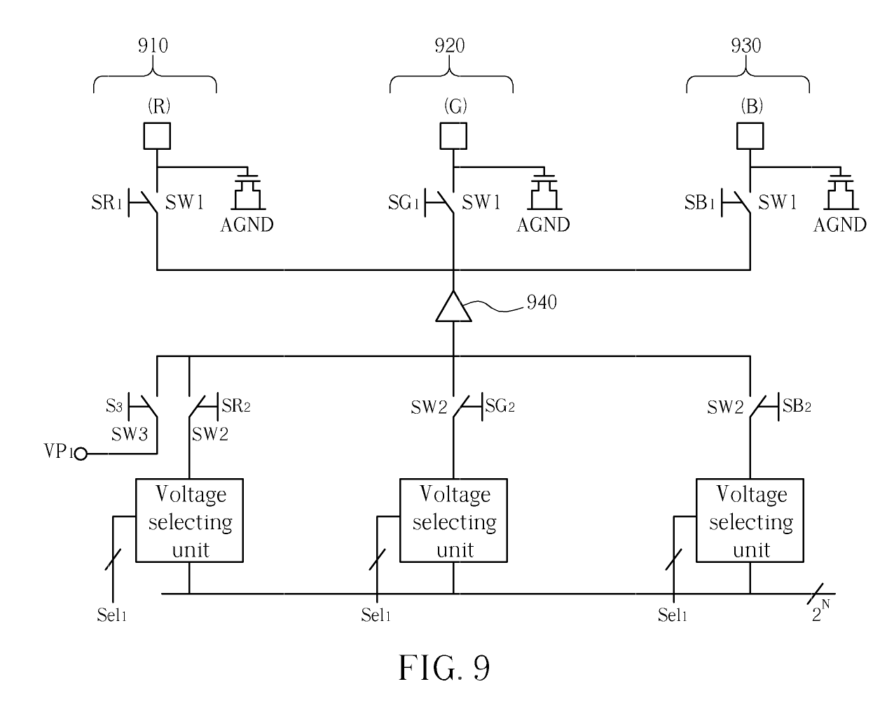

Please refer to FIG. 9. FIG. 9 is a diagram showing a plurality of voltage output circuit that correspond to an identical pixel sharing an identical output buffering unit (In FIG. 9, only a part of circuits are presented for illustration). As shown in FIG. 9, three output channels 910, 920, and 930 are respectively used for outputting Gamma voltages with Red, Green, and Blue that correspond to an identical pixel, wherein all of the voltage output circuits share the same output buffering unit 940.

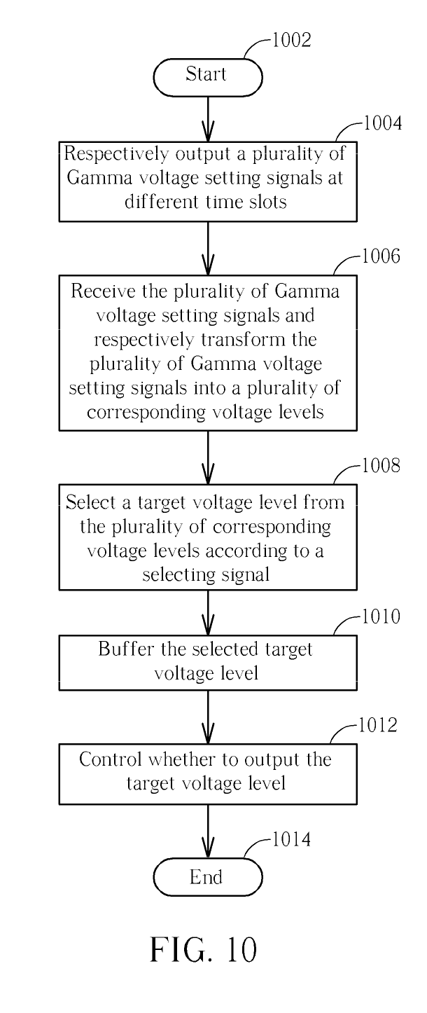

Please refer to FIG. 10. FIG. 10 is a flowchart illustrating a method for generating Gamma voltages according to an exemplary embodiment of the present invention. Please note that the following steps are not limited to be performed according to the exact sequence shown in FIG. 10 if a roughly identical result can be obtained. The method includes the following steps:

Step 1002: Start.

Step 1004: Respectively output a plurality of Gamma voltage setting signals at different time slots.

Step 1006: Receive the plurality of Gamma voltage setting signals and respectively transform the plurality of Gamma voltage setting signals into a plurality of corresponding voltage levels.

Step 1008: Select a target voltage level from the plurality of corresponding voltage levels according to a selecting signal.

Step 1010: Buffer the selected target voltage level.

Step 1012: Control whether to output the target voltage level.

Step 1014: End.

The following description details how each element operates by collocating the steps shown in FIG. 10 and the elements shown in FIG. 2. In Step 1004, the plurality of Gamma voltage setting signals R_Gamma, G_Gamma, and B_Gamma are respectively outputted by the setting circuit 210 at different time slots, wherein the plurality of Gamma voltage setting signals R_Gamma, G_Gamma, and B_Gamma respectively correspond to different color constituents, such as Red, Green, and Blue. The Gamma voltage generator 220 then respectively transforms the plurality of Gamma voltage setting signals R_Gamma, G_Gamma, and B_Gamma into a plurality of corresponding voltage levels γ₀ and γ₂^{N} (Step 1006). In Step 1008, the target voltage level Vₜ is selected from the plurality of corresponding voltage levels according to the selecting signal Sel₁ by each of the voltage selecting units 234-254 of the voltage output modules 230-250. Each output buffering unit 236-256 of the voltage output modules 230-250 buffers the selected target voltage level Vₜ selected by the voltage selecting units 230-250 (Step 1010) Finally, each output control circuit 238-258 of the voltage control modules 230-250 controls whether to output the target voltage level Vt (Step 1012).

Please note that the steps of the abovementioned flowchart are merely an exemplary embodiment of the present invention, and in no way should be considered to be limitations of the scope of the present invention. The method can include other intermediate steps without departing from the spirit of the present invention. Those skilled in the art should observe that various modifications of these methods may be made.

The abovementioned embodiments are presented merely for describing the present invention, and in no way should be considered to be limitations of the scope of the present invention. The abovementioned Gamma voltage generator 220 can be implemented by an R-ladder circuit, but is not limited to this only and can be implemented by other elements. In addition, the number N is not a fixed value and can be adjusted depending on practical applications. In one embodiment, the output control circuit can include at least one switch, but is not limited to this only and can be implemented by other elements. It will be obvious to those skilled in the art that various modifications of the output control circuits may be made without departing from the spirit of the present invention. The setting circuit 210 can include a plurality of setting switches. This is merely an example for describing the present invention, and in no way should be considered a limitation of the present invention. Please note that the abovementioned Gamma voltage driving circuit can be applied to a flat panel display, but is not limited to this only and can be applied to other devices. Please also note that the timing sequences of each switch signal mentioned above are presented merely for describing the present invention, and in no way should be considered to be limitations of the scope of the present invention. Those skilled in the art should observe that various modifications of the timing sequences of each switch signal may be made without departing the spirit of the present invention. The abovementioned embodiments are merely examples for describing the present invention, and in no way should be considered a limitation of the present invention. It will be obvious to those skilled in the art that various modifications of the Gamma voltage driving circuit may be made without departing from the spirit of the present invention. For example, the voltage level is pre-charged to the pre-charging voltage VP₁, or the voltage regulating device is added into each voltage output module, and this also belongs within the scope of the present invention. Furthermore, the steps of the method shown in FIG. 10 need not be in the exact order shown and need not be contiguous, and those skilled in the art should observe that various modifications of the method may be made without departing from the spirit of the present invention.

In summary, the present invention provides a Gamma voltage driving circuit and related method. Through controlling the timing sequences of each switch of the output control circuit collocating with the choice of each setting switch of the setting circuit, the Gamma voltages with Red, Green, and Blue can be sequentially driven (or the Gamma voltages with Blue, Green, and Red can be sequentially driven) by the Gamma voltage driving circuit within a period T of a scan line. In addition, through a concept of multiplexing with timing sharing, only one Gamma voltage generator 220 is necessary to complete the abovementioned actions. Therefore, even if the number of the voltage levels needs to be provided by the Gamma voltage driving circuit gets bigger, the manufacturing cost will not be increased.

Those skilled in the art will readily observe that numerous modifications and alterations of the device and method may be made while retaining the teachings of the invention.

What is claimed is:

1. A Gamma voltage driving circuit, comprising:
a setting circuit, used for respectively outputting a plurality of Gamma voltage setting signals at different time slots, the plurality of Gamma voltage setting signals respectively corresponding to different color constituents;
a Gamma voltage generator, coupled to the setting circuit, for receiving the plurality of Gamma voltage setting signals and for respectively transforming the plurality of Gamma voltage setting signals into a plurality of corresponding voltage levels; and
a plurality of voltage output modules, coupled to the Gamma voltage generator, the plurality of voltage output modules respectively corresponding to different color constituents and respectively providing voltage outputs at different time slots, each voltage output module comprising:
a plurality of voltage output circuits, each voltage output circuit comprising:
a voltage selecting unit, for choosing a target voltage level from the plurality of corresponding voltage levels according to a selecting signal; and
an output buffering unit, coupled to the voltage selecting unit, for buffering the target voltage level selected by the voltage selecting unit; and
a plurality of output control circuits, respectively coupled to the plurality of voltage output circuits, each output control circuit used for controlling the corresponding voltage output circuit to selectively output the target voltage level.

2. The Gamma voltage driving circuit of claim 1, wherein each output control circuit comprises a first switch coupled between an output end of the corresponding voltage output circuit and an output buffering unit of the corresponding voltage output circuit for selectively being turned on or turned off according to a first switch signal.

3. The Gamma voltage driving circuit of claim 2, wherein each output control circuit further comprises a second switch coupled between the output buffering unit of the voltage output circuit and a voltage selecting unit for selectively being turned on or turned off according to a second switch signal.

4. The Gamma voltage driving circuit of claim 3, wherein each voltage output circuit further comprises:
a third switch, respectively coupled between the output buffering unit and a pre-charging voltage, for selectively being turned on or turned off according to a third switch signal;
wherein only one of the second switch of each output control circuit and a third switch of the corresponding voltage output circuit is allowed to be turned on within an identical time slot.

5. The Gamma voltage driving circuit of claim 1, wherein each voltage output circuit further comprises a voltage regulating device coupled between the voltage selecting unit and the output buffering unit.

6. The Gamma voltage driving circuit of claim 1, wherein each voltage output circuit further comprises a voltage regulating device coupled to an output end of the output buffering unit.

7. The Gamma voltage driving circuit of claim 1, wherein the plurality of voltage output circuits that correspond to an identical pixel share an identical output buffering unit.

8. The Gamma voltage driving circuit of claim 1, wherein the setting circuit comprises a plurality of setting switches respectively coupled between the plurality of Gamma voltage setting signals and the Gamma voltage generator, and the plurality of setting switches are respectively being selectively turned on or turned off according to a plurality of setting switch signals to respectively output the plurality of Gamma voltage setting signals to the Gamma voltage generator at different time slots.

9. The Gamma voltage driving circuit of claim 1, wherein the color constituents comprises red (R), green (G), and blue (B).

10. The Gamma voltage driving circuit of claim 1, being applied to a flat panel display (FPD).

11. A method for generating Gamma voltages, comprising:
respectively outputting a plurality of Gamma voltage setting signals at different time slots, wherein the plurality of Gamma voltage setting signals respectively correspond to different color constituents;
receiving the plurality of Gamma voltage setting signals and respectively transforming the plurality of Gamma voltage setting signals into a plurality of corresponding voltage levels;
selecting a target voltage level from the plurality of corresponding voltage levels according to a selecting signal;
buffering the selected target voltage level; and
controlling whether to output the target voltage level.

12. The method of claim 11, wherein the step of controlling whether to output the target voltage level comprises:
selectively turning on or turning off a first switch according to a first switch signal to control whether to output the target voltage level.

13. The method of claim 12, wherein the step of controlling whether to output the target voltage level comprises:
selectively turning on or turning off a second switch according to a second switch signal to control whether to output the target voltage level.

14. The method of claim 13, further comprising:
selectively turning on or turning off a third switch according to a third switch signal to control whether to couple to a pre-charging voltage;
wherein only one of the second switch and the corresponding third switch is allowed to be turned on within an identical time slot.

15. The method of claim 11, wherein the step of respectively outputting the plurality of Gamma voltage setting signals at different time slots comprises:
selectively turning on or turning off a plurality of setting switches according to a plurality of setting switch signals to respectively output the plurality of Gamma voltage setting signals at different time slots.

16. The method of claim 11, wherein the color constituents comprises red (R), green (G), and blue (B).

17. The method of claim 11, being applied to a flat panel display.
